(19) United States
(12) Patent Application Publication
(10) Pub. No.: US 2020/0188942 A1
(43) Pub. Date: Jun. 18, 2020

(54) HEATING SYSTEM FOR PERFORMING THERMAL SPRAY COATING AND METHODS FOR USE

(71) Applicant: The Boeing Company, Chicago, IL (US)

(72) Inventor: Weidong Song, Seattle, WA (US)

(21) Appl. No.: 16/218,594

(22) Filed: Dec. 13, 2018

(51) Int. Cl. B05B 7/22; B05B 12/10; B05B 12/12; B23K 26/06; B25J 11/00

(52) U.S. Cl. CPC B05B 7/228; B05B 12/10; B25J 11/0075; B23K 26/0626; B23K 26/0648; B05B 12/12

(57) ABSTRACT

The present disclosure provides a heating system for performing thermal spray coating. The heating system includes (a) a thermal spray element configured to be coupled to a robotic arm, (b) a heating unit configured to be coupled to the robotic arm, (c) at least one processor, and (d) data storage comprising program instructions executable by the at least one processor to cause the heating system to perform functions including (i) receiving a first indication of a spray coating material positioned in the thermal spray element, (ii) receiving a second indication of a material of a substrate onto which the spray coating material is to be sprayed, (iii) heating the substrate for a time period until the substrate reaches a desired temperature that is determined based on both the spray coating material and the material of the substrate, and (iv) spraying the spray coating material onto the substrate.

### FIELD

The present disclosure relates generally to a heating system, and more particularly, to a heating system for performing thermal spray coating.

### BACKGROUND

Thermal spray coating involves heating a material, in powder or wire form, to a molten or semi-molten state. The heated material is then propelled using a stream of gas or compressed air to deposit a coating on a given substrate, thus creating a surface structure on the substrate. The material may be built up on the substrate in subsequent passes to form a final coating. The coating material may consist of a single element, or the coating material may consist of an alloy or composite with unique physical properties that are only achievable through the thermal spray process. Any material that can be melted and re-solidified can be used for such thermal spraying.

Thermal spray coating on a cold substrate may cause poor adhesion of the coating material on the substrate. Traditional approaches utilize an oven or other separate heating component to preheat the substrate before applying the spray coating material to the substrate. For aerospace applications, this approach may not work since many systems on an airplane cannot be heated. In addition, the substrates in airplane applications are difficult to maintain an elevated temperature due to the size, configuration, and material limitations. As such, an improved heating system and method for keeping a substrate material at a desired temperature while performing thermal spray coating may be desirable.

### SUMMARY

In one aspect, a heating system for performing thermal spray coating is described. The heating system includes (a) a thermal spray element configured to be coupled to a robotic arm, (b) a heating unit configured to be coupled to the robotic arm, (c) at least one processor, and (d) data storage comprising program instructions executable by the at least one processor to cause the heating system to perform functions. The functions include (i) receiving a first indication of a spray coating material positioned in the thermal spray element, (ii) receiving a second indication of a material of a substrate onto which the spray coating material is to be sprayed, (iii) heating, via the heating unit, the substrate for a time period until the substrate reaches a desired temperature, wherein the desired temperature is determined based on both the first indication of the spray coating material and the second indication of the material of the substrate, and (iv) spraying, via the thermal spray element, the spray coating material onto the substrate.

In another aspect, a method operable by a heating system is described, wherein the heating system includes a thermal spray element and a heating unit. The method includes (a) receiving a first indication of a spray coating material positioned in the thermal spray element, (b) receiving a second indication of a material of a substrate onto which the spray coating material is to be sprayed, (c) heating, via the heating unit, the substrate for a time period until the substrate reaches a desired temperature, wherein the desired temperature is determined based on both the first indication of the spray coating material and the second indication of the material of the substrate, and (d) spraying, via the thermal spray element, the spray coating material onto the substrate.

In yet another aspect, a non-transitory computer readable medium is described. The non-transitory computer readable medium includes stored thereon instructions, that when executed by one or more processors, cause a heating system including a thermal spray element and a heating unit to perform operations. The operations include (a) receiving a first indication of a spray coating material positioned in the thermal spray element, (b) receiving a second indication of a material of a substrate onto which the spray coating material is to be sprayed, (c) heating, via the heating unit, the substrate for a time period until the substrate reaches a desired temperature, wherein the desired temperature is determined based on both the first indication of the spray coating material and the second indication of the material of the substrate, and (d) spraying, via the thermal spray element, the spray coating material onto the substrate.

The features, functions, and advantages that have been discussed can be achieved independently in various examples or may be combined in yet other examples further details of which can be seen with reference to the following description and figures.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative examples of the present disclosure when read in conjunction with the accompanying figures.

FIG. 1 is a block diagram of an example heating system, according to an example embodiment.

FIG. 2 is a simplified diagram of an example heating system with a robotic arm, according to an example embodiment.

FIG. 3 is a simplified diagram of another example heating system with two robotic arms, according to an example embodiment.

FIG. 4 is a block diagram of an example computing device, according to an example embodiment.

FIG. 5 is a flowchart of an example method, according to an example embodiment.

### DETAILED DESCRIPTION

Disclosed embodiments will now be described more fully hereinafter with reference to the accompanying figures, in which some, but not all of the disclosed embodiments are shown. Indeed, several different embodiments may be provided and should not be construed as limited to the embodiments set forth herein. Rather, these embodiments are provided so that this disclosure will be thorough and complete and will fully convey the scope of the disclosure to those skilled in the art.

In the following description, numerous specific details are set forth to provide a thorough understanding of the disclosed concepts, which may be practiced without some or all of these particulars. In other instances, details of known devices and/or processes have been omitted to avoid unnecessarily obscuring the disclosure. While some concepts will be described in conjunction with specific examples, it will be understood that these examples are not intended to be limiting.

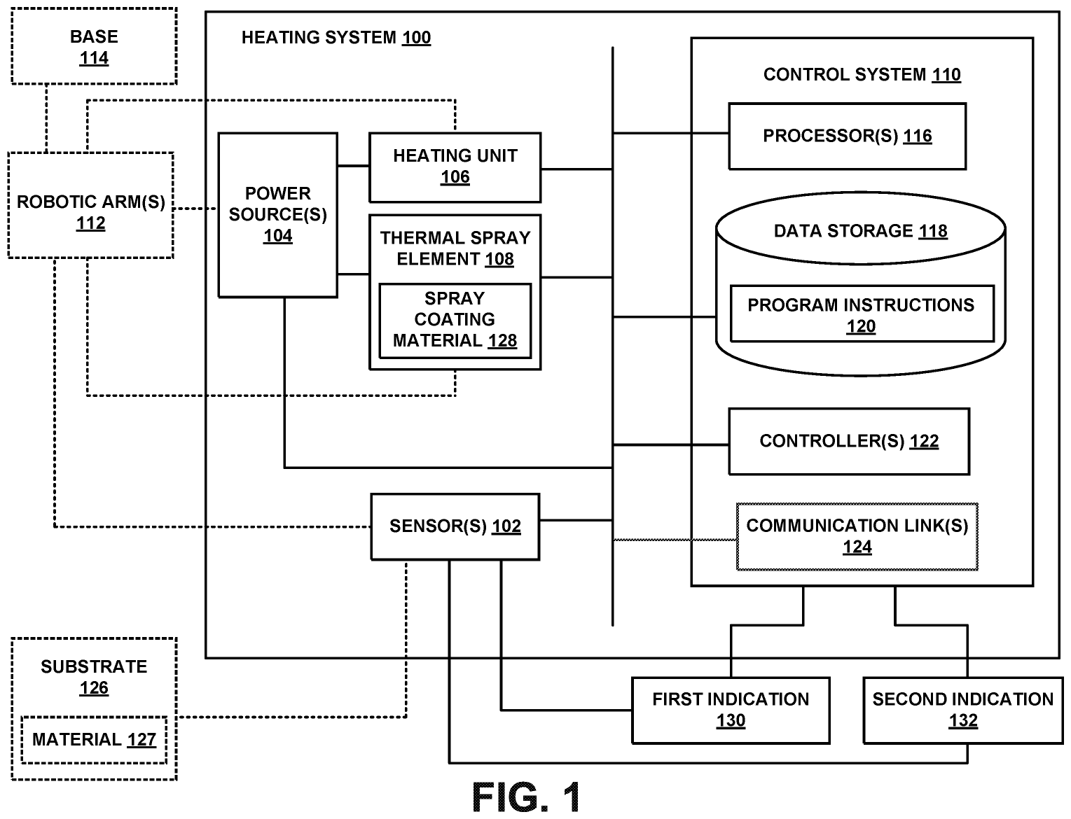

In FIG. 1, solid lines, if any, connecting various elements and/or components may represent mechanical, electrical, fluid, optical, electromagnetic and other couplings and/or combinations thereof. As used herein, “coupled” means associated directly as well as indirectly. For example, a member A may be directly associated with a member B, or may be indirectly associated therewith, e.g., via another member C. It will be understood that not all relationships among the various disclosed elements are necessarily represented. Accordingly, couplings other than those depicted in the block diagrams may also exist. Dashed lines, if any, connecting blocks designating the various elements and/or components represent couplings similar in function and purpose to those represented by solid lines; however, couplings represented by the dashed lines may either be selectively provided or may relate to alternative examples of the present disclosure. Likewise, elements and/or components, if any, represented with dashed lines, indicate alternative examples of the present disclosure. One or more elements shown in solid and/or dashed lines may be omitted from a particular example without departing from the scope of the present disclosure. Environmental elements, if any, are represented with dotted lines. Virtual (imaginary) elements may also be shown for clarity. Those skilled in the art will appreciate that some of the features illustrated in FIG. 1 may be combined in various ways without the need to include other features described in FIG. 1, other drawing figures, and/or the accompanying disclosure, even though such combination or combinations are not explicitly illustrated herein. Similarly, additional features not limited to the examples presented, may be combined with some or all of the features shown and described herein.

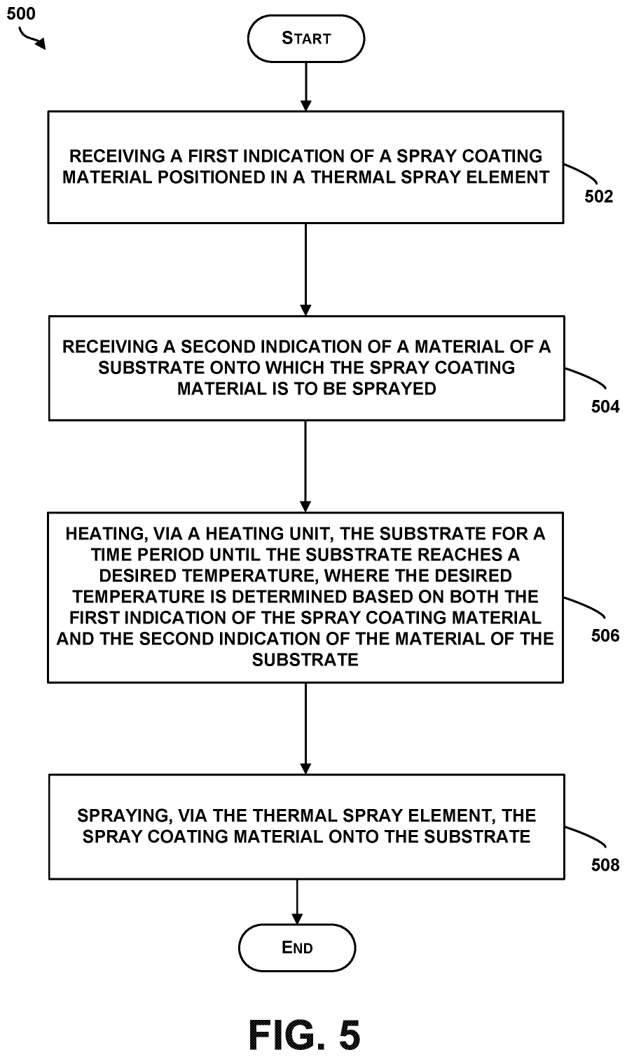

In FIG. 5, the blocks may represent operations and/or portions thereof and lines connecting the various blocks do not imply any particular order or dependency of the operations or portions thereof. It will be understood that not all dependencies among the various disclosed operations are necessarily represented. FIG. 5 and the accompanying disclosure describing the operations of the method(s) set forth herein should not be interpreted as necessarily determining a sequence in which the operations are to be performed. Rather, although one illustrative order is indicated, it is to be understood that the sequence of the operations may be modified when appropriate. Accordingly, certain operations may be performed in a different order or simultaneously. Additionally, those skilled in the art will appreciate that not all operations described need be performed.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Reference herein to “one embodiment” or “one example” means that one or more feature, structure, or characteristic described in connection with the example is included in at least one implementation. The phrases “one embodiment” or “one example” in various places in the specification may or may not be referring to the same example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

As used herein, with respect to measurements, “about” and “substantially” each means +/−5%.

Illustrative, non-exhaustive examples, which may or may not be claimed, of the subject matter according the present disclosure are provided below.

Within examples, a heating system for performing thermal spray coating is described herein. Thermal spray coating requires the substrate to be the correct temperature for the thermal spray coating material to bond thereto to form a film on the substrate. If the substrate is too cold, a layer may form between the spray coating material and the substrate. In such an example, shrinkage of the spray coating material film on the substrate can occur which may result in the spray coating material peeling off of the substrate. Traditional approaches heat the substrate using an oven as a separate step prior to applying the spray coating material. The system described herein provides an in-situ heating system that eliminates the need to preheat the substrate in a separate step, and therefore makes the production flow much simpler. In particular, the heating system described herein keeps selected areas of a large substrate material at the desired temperature during the thermal spray coating process. The heating system achieves such heating effect in a short time period, and the heating system can be integrated into a robotic arm or other end effector that enables fast application and a high level of automation.

Various other features of the example systems discussed above, as well as methods for using these systems, are also described hereinafter with reference to the accompanying figures.

With reference to the Figures, FIG. 1 illustrates an example configuration of a heating system that may be used in connection with the implementations described herein. The heating system 100 may be configured to operate autonomously, semi-autonomously, and/or using directions provided by user(s).

As shown in FIG. 1, the heating system 100 may include sensor(s) 102, power source(s) 104, a heating unit 106, a thermal spray element 108, and a control system 110. The heating system 100 is shown for illustrative purposes, and may include more or fewer components. The various components of heating system 100 may be connected in any manner, including wired or wireless connections. Further, in some examples, components of the heating system 100 may be distributed among multiple physical entities rather than a single physical entity. Other example illustrations of heating system 100 may exist as well.

The sensor(s) 102 may include, for example, one or more force sensors, torque sensors, velocity sensors, acceleration sensors, position sensors, proximity sensors, motion sensors, location sensors, load sensors, temperature sensors, touch sensors, depth sensors, ultrasonic range sensors, infrared sensors, object sensors, and/or cameras, among other possibilities. Within some examples, the heating system 100 may be configured to receive sensor data from sensors that are physically separated from the heating system 100 (e.g., sensors that are positioned on a robotic arm(s) 112 that is coupled to the heating system 100 or sensors that are located within the environment in which the heating system 100 is operating).

The heating system 100 may include sensor(s) 102 configured to receive information indicative of the state of the heating system 100, including sensor(s) 102 that may monitor the state of the various components of the heating system 100. The sensor(s) 102 may measure activity of systems of the heating system 100 and receive information based on the operation of the various features of the heating system 100, such the operation of the heating unit 106 and/or the thermal spray element 108. In one particular example, the sensor(s) 102 may detect a material 127 of the substrate 126 for a thermal spray coating application and/or the spray coating material 128 used for the thermal spray coating application, and the heating system 100 may adjust one or more operational parameters of the heating unit 106 and/or the thermal spray element 108 based on the determination. The data provided by the sensor(s) 102 may enable the control system 110 to determine errors in operation as well as monitor overall operation of components of the heating system 100.

Further, the sensor(s) 102 may provide sensor data to the control system 110 to allow for interaction of the heating system 100 with its environment, as well as monitoring of the operation of the heating system 100. The sensor data may be used in evaluation of various factors for activation, movement, and deactivation of the heating unit 106 and/or the thermal spray element 108 by the control system 110. In one example, the sensor(s) may be coupled to and/or in communication with one or more robotic arm(s) 112. In such an example, the sensor(s) 102 may capture data corresponding to the objects in the environment, which may assist with environment recognition and navigation of the robotic arm(s) 112. In an example configuration, sensor(s) 102 may include RADAR, LiDAR, infrared (IR), ultrasonic, one or more cameras (e.g., stereoscopic cameras for 3D vision), a global positioning system (GPS) transceiver, and/or other sensors for capturing information of the environment in which the robotic arm(s) are operating. In another example, the sensor(s) 102 may include one or more velocity and/or acceleration sensors. For instance, the sensor(s) 102 may include an inertial measurement unit (IMU). The sensor(s) 102 may monitor the environment in real time, and detect obstacles and/or other aspects of the environment.

The heating system 100 may include other types of sensors not explicated discussed herein. Additionally or alternatively, the heating system 100 may use particular sensors for purposes not enumerated herein.

The heating system 100 may also include one or more power source(s) 104 configured to supply power to various components of the heating system 100. Among other possible power systems, the heating system 100 may include, for example, a hydraulic system, electrical system, batteries, electrical power, a gasoline engine, and/or other types of power systems. As an example illustration, the heating system 100 may include one or more batteries configured to provide charge to components of the heating system 100. The power source(s) 104 may charge using various types of charging, such as wired connections to an outside power source, wireless charging, combustion, or other examples.

In one example, as shown in FIG. 1, the heating unit 106 and/or the thermal spray element 108 are configured to be coupled to one or more robotic arm(s) 112. In one example, a direction of the thermal spray element 108 and a direction of the heating unit 106 are independently controllable with respect to the robotic arm(s) 112. Such an arrangement provides flexibility to direct the heating unit 106 in a different direction than the thermal spray element 108. The robotic arm(s) 112 may be mounted on or connected to a base 114. In one example, the base 114 is permanently coupled to a surface within a manufacturing environment. In another example, the base 114 may be a mobile base configured to move about an environment using different means of movement including, for example, wheels, tracks, legs, and/or any combinations or variations thereof. The heating unit 106 and/or the thermal spray element 108 coupled to the robotic arm(s) 112 may act as end effectors of the robotic arm(s) 112. As such, the heating unit 106 and/or the thermal spray element 108 may be modular, allowing different types of heating units 106 and/or thermal spray elements 108 to be attached depending on the particular task performed by the heating system 100. For example, different types of heating units 106 and/or thermal spray elements 108 can be used depending on a type of the substrate 126 and a type of the spray coating material 128 used. In another example, a first robotic arm may be coupled to the heating unit 106, and a second robotic arm is coupled to the thermal spray element 108.

As shown in FIG. 1, the control system 110 may include processor(s) 116, data storage 118, controller(s) 122, and communication link(s) 124. Processor(s) 116 may operate as one or more general-purpose hardware processors or special purpose hardware processors (e.g., digital signal processors, application specific integrated circuits, etc.). The processor(s) 116 may be configured to execute computer-readable program instructions 120 stored in the data storage 118. The processor(s) 116 may also directly or indirectly interact with other components of the heating system 100, such as sensor(s) 102, power source(s) 104, heating unit 106, thermal spray element 108, robotic arm(s) 112, and/or communication link(s) 124.

The data storage 118 may be one or more types of hardware memory. For example, the data storage 118 may include or take the form of one or more computer-readable storage media that can be read or accessed by processor(s) 116. The one or more computer-readable storage media can include volatile and/or non-volatile storage components, such as optical, magnetic, organic, or another type of memory or storage, which can be integrated in whole or in part with processor(s) 116. In some implementations, the data storage 118 can be a single physical device. In other implementations, the data storage 118 can be implemented using two or more physical devices, which may communicate with one another via wired or wireless communication. As noted previously, the data storage 118 may include the computer-readable program instructions 120, as well as additional data. The additional data may be any type of data, such as configuration data, sensor data, and/or diagnostic data, among other possibilities.

The controller(s) 122 may include one or more electrical circuits, units of digital logic, computer chips, and/or microprocessors that are configured to (perhaps among other tasks), interface between any combination of the sensor(s) 102, the power source(s) 104, the heating unit 106, the thermal spray element 108, the control system 110, the robotic arm(s) 112, the communication link(s) 124, and/or a user of the heating system 100. In some implementations, the controller(s) 122 may be a purpose-built embedded device for performing specific operations with one or more subsystems of the heating system 100.

The control system 110 may monitor and physically change the operating conditions of the heating system 100. In doing so, the control system 110 may serve as a link between portions of the heating system 100, such as between sensor(s) 102 and/or the heating unit 106 or thermal spray element 108, between the heating system 100 and another computing device, and/or or between the heating system 100 and a user. The example interfaces and communications noted above may be implemented via a wired or wireless connection, or both. The control system 110 may perform other operations for the heating system 100 as well.

In some implementations, the control system 110 of heating system 100 may also include communication link(s) 124 configured to send and/or receive information. The communication link(s) 124 may transmit data indicating the state of the various components of the heating system 100. For example, information read by sensor(s) 102 may be transmitted via the communication link(s) 124 to a separate device. Other diagnostic information indicating the integrity or health of the power source(s) 104, heating unit 106, thermal spray element 108, robotic arm(s) 112, processor(s) 116, data storage 118, and/or controller(s) 122 may be transmitted via the communication link(s) 124 to an external communication device.

In some implementations, the heating system 100 may receive information at the communication link(s) 124 that is then processed by the processor(s) 116. The received information may indicate data that is accessible by the processor(s) 116 during execution of the computer-readable program instructions 120. Further, the received information may change aspects of the controller(s) 122 that may affect the behavior of the heating unit 106 and/or the thermal spray element 108.

In some cases, the communication link(s) 124 may include a wired connection. The heating system 100 may include one or more ports to interface the communication link(s) 124 to an external device. The communication link(s) 124 may include, in addition to or as an alternative to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, Bluetooth, or a near-field communication (NFC) device.

Operations of the control system 110 may be carried out by the processor(s) 116. Alternatively, these operations may be carried out by the controller(s) 122, or a combination of the processor(s) 116 and the controller(s) 122. In some implementations, the control system 110 may partially or wholly reside on a device other than the heating system 100, and therefore may at least in part control the heating system 100 remotely. The communication link(s) 124 may be used at least in part to carry out the remote communication.

During operation, the control system 110 may communicate with other systems of the heating system 100 via wired or wireless connections, and may further be configured to communicate with one or more users of the heating system 100. As one possible illustration, the control system 110 may receive an input (e.g., from a user) indicating an instruction to perform a particular set of one or more tasks. The input to control system 110 may be received via the communication link(s) 124. Based on this input, the control system 110 may perform operations to cause the heating system 100 to perform one or more tasks.

In particular, such tasks may include (a) receiving a first indication 130 of a spray coating material 128 positioned in the thermal spray element 108, (b) receiving a second indication 132 of a material 127 of a substrate 126 onto which the spray coating material 128 is to be sprayed, (c) heating, via the heating unit 106, the substrate 126 for a time period until the substrate 126 reaches a desired temperature, where the desired temperature is determined based on both the first indication 130 of the spray coating material 128 and the second indication 132 of the material 127 of the substrate 126, and (d) spraying, via the thermal spray element 108, the spray coating material 128 onto the substrate 126.

In one example, the first indication 130 of the spray coating material 128 and/or the second indication 132 of the material 127 of the substrate 126 is transmitted to the control system 110 of the heating system 100 via a user input. In such an example, a user may transmit the first indication 130 and/or the second indication 132 via a computing device. Such a computing device may be incorporated into the heating system 100 and/or the robotic arm 112, or the computing device may be an independent component in wireless communication with the heating system 100 and/or robotic arm 112. In some examples, the computing device may receive information from the sensor(s) 102 or other components coupled to the computing device, or where the computing device is a server the information can be received from another device that collects the information. The computing device could further communicate with a server to determine information that may facilitate the performance of the heating system 100.

In another example, the sensor(s) 102 may detect the spray coating material 128, and may transmit the first indication 130 of the spray coating material 128 to the control system 110 of the heating system 100. Similarly, the sensor(s) 102 may detect the material 127 of the substrate 126, and may transmit the second indication 132 of the material 127 of the substrate 126 to the control system 110 of the heating system 100. The control system 110 may then adjust one or more operational parameters of the heating system 100 based on the received first indication 130 and the received second indication 132.

The time period for heating the substrate 126 may range from about 2 seconds to about 60 seconds, and preferably from about 2 seconds to about 10 seconds. In various particular examples, the time period for heating the substrate 126 may range from about 4 seconds to about 10 seconds, or from about 6 seconds to about 10 seconds. In another example, the time period for heating the substrate 126 may be about 2 seconds, about 4 seconds, about 6 seconds, about 8 seconds, or about 10 seconds. Other ranges are possible as well.

The desired temperature of the substrate 126 may range from about 120° F. to about 750° F., and preferably from about 120° F. to about 250° F. In various particular examples, the desired temperature of the substrate 126 may range from about 120° F. to about 240° F., from about 120° F. to about 230° F., from about 120° F. to about 220° F., from about 120° F. to about 210° F., from about 120° F. to about 200° F., from about 120° F. to about 190° F., from about 120° F. to about 180° F., from about 120° F. to about 170° F., from about 120° F. to about 160° F., or from about 120° F. to about 150° F. In another example, the desired temperature of the substrate 126 may be about 120° F., about 130° F., about 140° F., about 150° F., about 160° F., about 170° F., about 180° F., about 190° F., about 200° F., about 210° F., about 220° F., about 230° F., about 240° F., or about 250° F. Other temperature ranges are possible as well.

In one example, as discussed above, the sensor(s) 102 include a temperature sensor. In such an example, the tasks further comprise detecting, via the sensor, a temperature of the substrate 126, and adjusting a power of the heating unit 106 based on the detected temperature of the substrate 126.

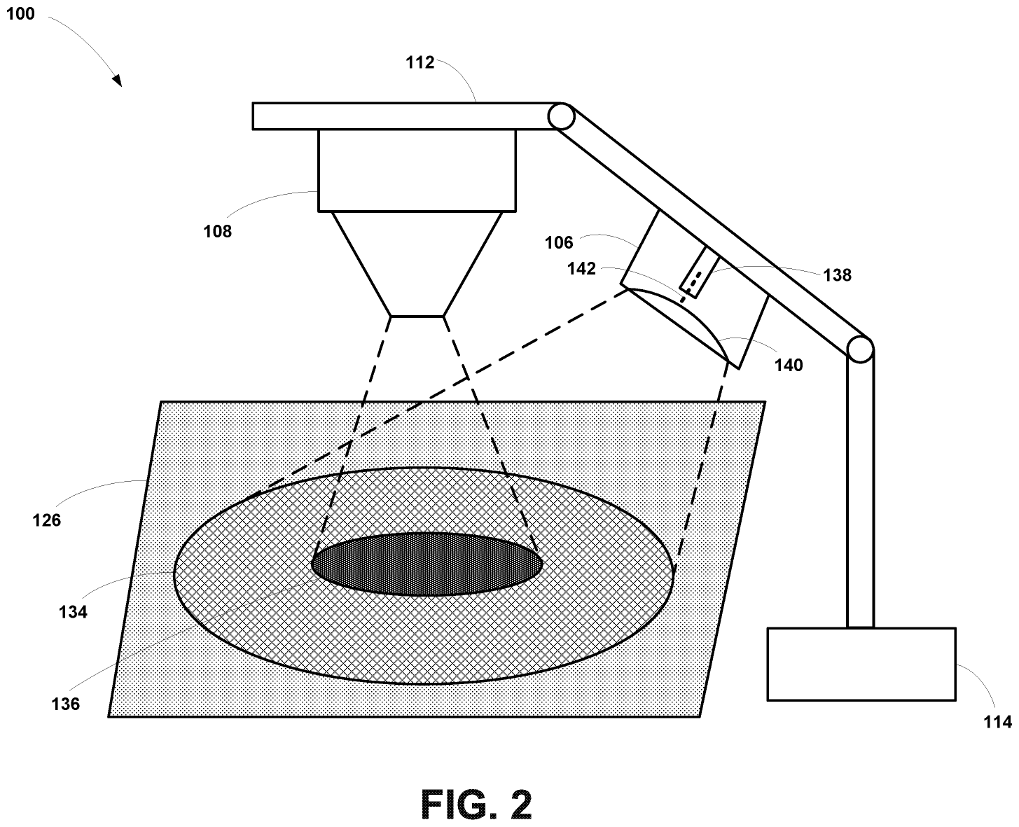

FIG. 2 illustrates a simplified diagram of one embodiment of the heating system 100 for performing thermal spray coating. The heating system 100 shown in FIG. 2 may include one or more components of the heating system 100 shown in FIG. 1, and may be configured to carry out the operations described herein. Thus, the heating system 100 may include one or more of sensor(s) 102, power source(s) 104, heating unit 106, thermal spray element 108, and/or control system 110.

In particular, as shown in FIG. 2, the heating system 100 includes a heating unit 106 configured to be coupled to a robotic arm 112. The robotic arm 112 may be mounted on or connected to a base 114. In one example, the base 114 is permanently coupled to a surface within a manufacturing environment. In another example, the base 114 may be a mobile base configured to move about an environment using different means of movement including, for example, wheels, tracks, legs, and/or any combinations or variations thereof. The heating system 100 further includes a thermal spray element 108 coupled to the robotic arm 112. As discussed above, a direction of the thermal spray element 108 and a direction of the heating unit 106 may be independently controllable with respect to the robotic arm 112. As shown in FIG. 2, the thermal spray element 108 may be maintained at approximately 90° with respect to the substrate 126 so that the spray coating material 128 contacts the substrate 126 in a normal direction. In such an embodiment, as shown in FIG. 2, the heating unit 106 may be positioned at an angle with respect to the thermal spray element 108. The angle between the heating unit 106 and the thermal spray element 108 should be minimized to increase the efficiency of the heating unit 106.

The heating unit 106 may take a variety of forms. In one example, the heating unit 106 comprises an infrared heating unit. In such an example, the heating unit 106 transfers energy to a substrate 126 through electromagnetic radiation. As such, no contact or medium between the heating unit 106 and the substrate 126 is needed for the energy transfer. In another example, the heating unit 106 comprises an induction heating unit. In such an example, the heating unit 106 includes an electromagnet, and an electronic oscillator that passes a high-frequency alternating current through the electromagnet. The rapidly alternating magnetic field penetrates the substrate 126, generating electric currents inside the substrate 126. The electrical currents flowing through the resistance of the substrate 126 heat the substrate 126 by Joule heating. In such an example, the heat is generated inside the substrate 126 itself, instead of by an external heat source via heat conduction. In addition, as with the infrared heating unit example, there need not be any external contact in the induction heating unit example. In yet another example, the heating unit 106 comprises a laser 138, as shown in FIG. 2. In such an example, the heating unit 106 may also include a lens 140 positioned between the laser 138 and the substrate 126 to diffuse a laser beam 142 from the laser 138 onto the substrate 126. Other example configurations for the heating unit or combinations of the examples above are possible as well.

The thermal spray element 108 may take a variety of forms as well, and may include one or more components. In one example, the thermal spray element 108 comprises a combustion powder spray gun, which can use oxy-fuel flame to melt the spray coating material 128 when in a powder form, and propel the melted powder spray coating material to the substrate 126. In another example, the thermal spray element 108 comprises a combustion wire spray gun, which can use oxy-fuel flame to melt the spray coating material 128 when in a wire form, and propel the melted wire spray coating material to the substrate 126. In another example, the thermal spray element 108 comprises a low pressure plasma spray gun, which can apply a plasma coating in a vacuum chamber. In such an example, the plasma may consist of an ionized gas produced in an electric arc that melts a powder spray coating material 128 and propels the coating to the substrate 126. In another example, the thermal spray element 108 comprises a detonation gun spray, which provides pulsed controlled combustion of fuel and oxygen to melt and propel the spray coating material 128 to substrate 126. In one such example, acetylene may be used in addition to components described above in the detonation gun spray to melt and propel the spray coating material 128 to the substrate 126. Other example thermal spray elements are possible as well.

As shown in FIG. 2, the heating unit 106 heats a localized heating zone 134 of a substrate 126 when in use. The localized heating zone 134 comprises a subset of a surface area of the substrate 126. Such an arrangement provides precision in heating to reduce waste in power, and allows the substrate 126 to sufficiently heat to the desired temperature before spraying. As shown in FIG. 2, the thermal spray element 108 has a spray coating area 136 that is less than an area of the localized heating zone 134. The localized heating zone 134 may range from about 5 cm² to about 50 cm², and the spray coating area 136 may range from about 25 cm² to about 500 cm².

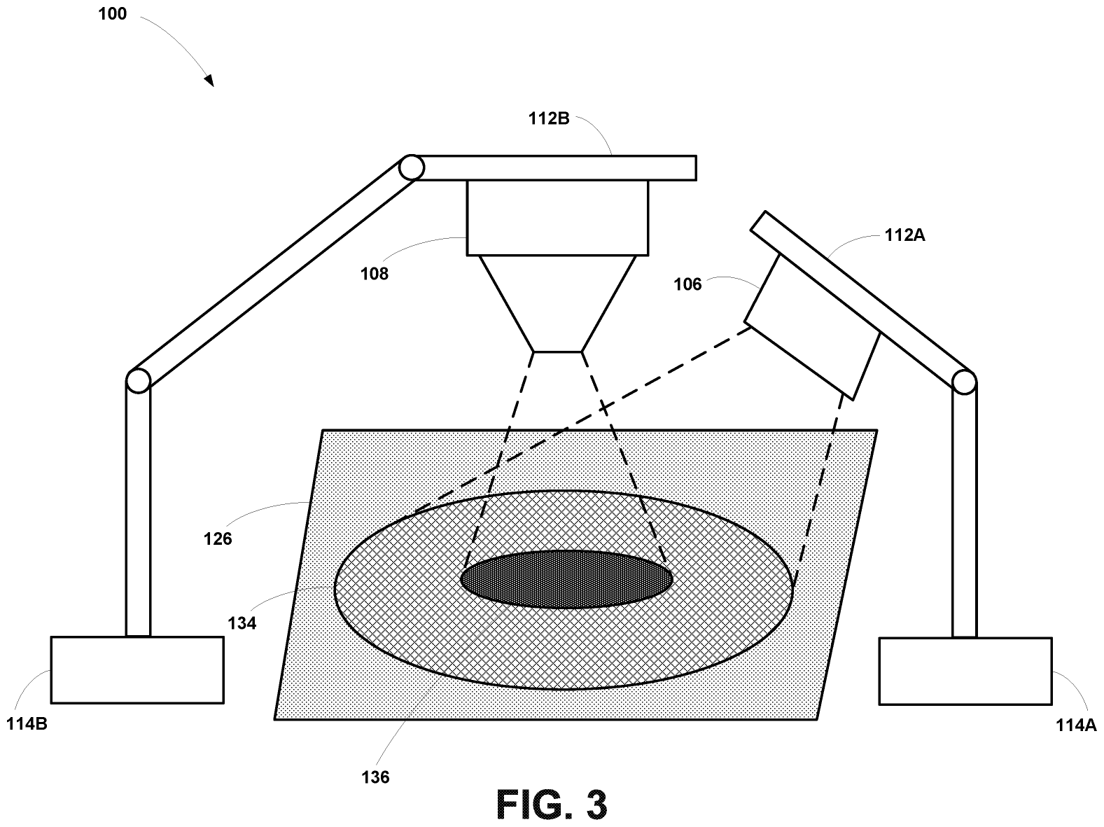

FIG. 3 illustrates another example of a heating system 100 for performing thermal spray coating. The heating system 100 shown in FIG. 3 may include one or more components of the heating system 100 shown in FIG. 1 and/or the heating system 100 shown in FIG. 2, and may be configured to carry out the operations described herein. Thus, the heating system 100 may include one or more of sensor(s) 102, power source(s) 104, heating unit 106, thermal spray element 108, and/or control system 110.

In particular, as shown in FIG. 3, the heating system 100 may include a heating unit 106 configured to be coupled to a first robotic arm 112A. The first robotic arm 112A may be mounted on or connected to a first base 114A. The heating system 100 further includes a thermal spray element 108 coupled to a second robotic arm 112B. The second robotic arm 112B may be mounted on or connected to a second base 114B. The first base 114A and/or the second base 114B may be similarly configured to the base 114 described in relation to FIG. 2. A direction of the heating unit 106 and a direction of the thermal spray element 108 may be independently controllable using the first robotic arm 112A and the second robotic arm 112B, respectively. As shown in FIG. 3, the thermal spray element 108 may be maintained at approximately 90° with respect to the substrate 126 so that the spray coating material 128 contacts the substrate 126 in a normal direction. In one example, the heating unit 106 may be positioned at an angle with respect to the thermal spray element 108. In another example, the angle between the heating unit 106 and the thermal spray element 108 is zero to thereby increase the efficiency of the heating unit 106.

As shown in FIG. 3, the heating unit 106 heats a localized heating zone 134 of a substrate 126 when in use. The localized heating zone 134 comprises a subset of a surface area of the substrate 126. As shown in FIG. 3, the thermal spray element 108 has a spray coating area 318 that is less than an area of the localized heating zone 134. In one example, the second robotic arm 112B including the thermal spray element 108 may be configured to follow a path of the first robotic arm 112A including the heating unit 106. For example, the second robotic arm 112B may follow about 2 seconds to about 10 seconds behind the first robotic arm 112A, so that the heating unit 106 has time to sufficiently heat the substrate 126 to the desired temperature before the thermal spray element 108 provides the spray coating material to the substrate 126.

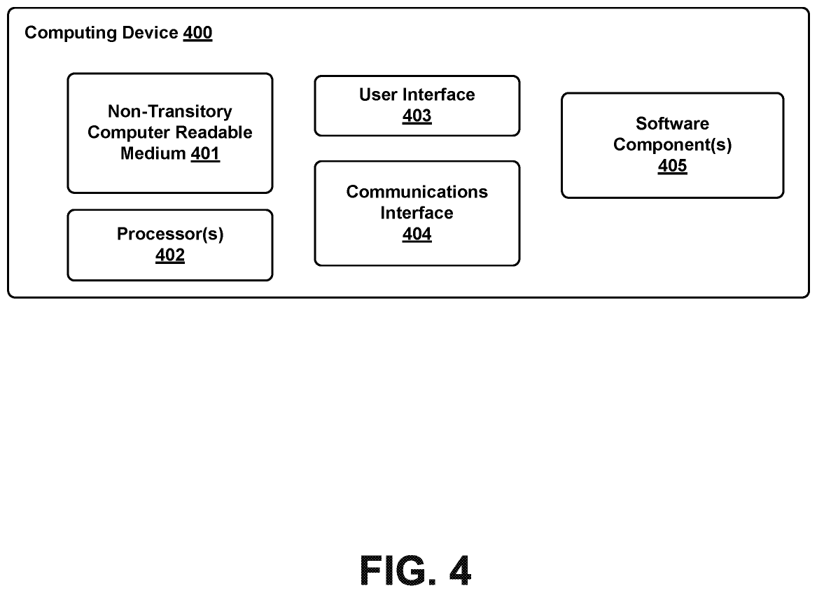

FIG. 4 illustrates a block diagram of an example of a computing device 400 that may be used to implement some or all of the operations discussed herein. For instance, the computing device 400 may be an onboard computer on the heating system 100 described above, or it may be a remote computer that is communicatively coupled to the heating system 100 via a communications link. Further, the computing device 400 shown in FIG. 4 might not be embodied by a single device, but may represent a combination of computing devices that may or may not be in the same location.

The computing device 400 may include a non-transitory computer readable medium 401 that includes instructions that are executable by one or more processors 402. The non-transitory computer readable medium 401 may include other data storage as well, such as navigation data. For example, the heating system 100 may store data in the non-transitory computer readable medium 401 corresponding to a desired temperature of the substrate for various substrate materials and spray coating materials.

In some implementations, the computing device 400 may include a user interface 403 for receiving inputs from a user, and/or for outputting operational data to a user. The user interface 403 might take the form of a control panel located on the heating system 100 or a graphical user interface at a remote location connected to the heating system 100 via a communications interface 404, among other examples. For instance, a command for using heating system 100 to heat the substrate for a time period until the substrate reaches a desired temperature may be received from a remote user via the user interface 403. The command may be received by the heating system 100 via a communications interface 404. In other examples, operations of the heating system 100 might be initiated automatically, based on pre-determined parameters stored on the non-transitory computer readable medium 401. Other possibilities also exist.

In addition, the non-transitory computer readable medium 401 may be loaded with one or more software components 405 stored on the non-transitory computer readable medium 401 and executable by the processor 402 to achieve certain functions. For example, the heating system 100 may include various systems that contribute to its operation, such as sensor(s) 102, power source(s) 104, heating unit 106, thermal spray element 108, control system 110, and/or robotic arm(s) 112, among other examples as discussed above. Each of these systems may be operated in part by software components 405 housed on the non-transitory computer readable medium 401 and executable by the processor 402.

FIG. 5 is a block diagram of an example method operable by a heating system. The heating system may comprise the heating system 100 described above in relation to FIGS. 1-3. As such, method 500 shown in FIG. 5 presents an embodiment of a method that could be used by the heating system 100 described above, as an example. Method 500 includes one or more operations, functions, or actions as illustrated by one or more of blocks 502-508. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

In addition, for the method 500 and other processes and methods disclosed herein, the block diagram shows functionality and operation of one possible implementation of present embodiments. In this regard, the method 500 can be caused to be performed by program code, which includes one or more instructions executable by a processor or computing device for implementing specific logical functions or steps in the process. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device.

In addition, for the method 500 and other processes and methods disclosed herein, each block in FIG. 5 may represent circuitry that is wired to perform the specific logical functions in the process.

Initially, at block 502, the method 500 includes receiving a first indication 130 of a spray coating material 128 positioned in a thermal spray element 108. As discussed above, in one example, the first indication 130 of the spray coating material 128 is received via a user input. In another example, one or more sensors 102 of the heating system 100 may detect the spray coating material 128, and may transmit the first indication 130 of the spray coating material 128 to the control system 110 of the heating system 100.

At block 504, the method 500 includes receiving a second indication 132 of a material 127 of a substrate 126 onto which the spray coating material 128 is to be sprayed. As discussed above and similar to the first indication 130 of the spray coating material 128, in one example, the second indication 132 of the material 127 of the substrate 126 is received via a user input. In another example, one or more sensors 102 of the heating system 100 may detect the material 127 of the substrate 126, and may transmit the second indication 132 of the material 127 of the substrate 126 to the control system 110 of the heating system 100.

At block 506, the method 500 includes heating, via a heating unit 106, the substrate 126 for a time period until the substrate 126 reaches a desired temperature, where the desired temperature is determined based on both the first indication 130 of the spray coating material 128 and the second indication 132 of the material 127 of the substrate 126. In one example, heating the substrate 126 for a time period comprises heating the substrate 126 for about 2 seconds to about 60 seconds, and preferably for a time period between about 2 seconds and about 10 seconds. In addition, heating the substrate 126 to the desired temperature may comprise heating the substrate 126 to a temperature ranging from about 120° F. to about 750° F., and preferably between a temperature of about 120° F. to about 250° F. Further, heating the substrate 126 may comprise the heating unit 106 heating a localized heating zone 134 of the substrate 126, where the localized heating zone 134 comprises a subset of a surface area of the substrate 126, and where spraying the spray coating material 128 on the substrate 126 comprises the thermal spray element 108 spraying a spray coating area 136 that is less than an area of the localized heating zone 134.

At block 508, the method 500 includes spraying, via the thermal spray element 108, the spray coating material 128 onto the substrate 126. In one particular example, the spray coating material 128 may be selected to have chemical resistance for a fuel tank environment (e.g., jet fuel and/or hydraulic fluids), mechanical properties such as strength and elongation, adhesion to the material 127 of the substrate 126, and surface/volumetric conductivity. As such, in one example spraying the spray coating material 128 onto the substrate 126 comprises spraying one of polyether ether ketone (PEEK), polyetherketoneketone (PEKK), or a thermoplastic polyester elastomer. Other spray coating materials are possible as well.

In another example, the method 500 further comprises controlling a direction of the thermal spray element 108 independently from a direction of the heating unit 106. Such an arrangement provides flexibility to direct the heating unit 106 in a different direction than the thermal spray element 108. In operation, the heating unit 106 may be pointed in a direction in front of the thermal spray element 108 with respect to the direction of movement of the robotic arm 112. Such an arrangement ensures that the substrate 126 is sufficiently heated to the desired temperature prior to spraying the spray coating material 128 onto the substrate 126.

In another example, the method 500 further includes detecting, via a sensor 102 of the heating system 100, a temperature of the substrate 126, and adjusting a power of the heating unit 106 based on the detected temperature of the substrate 126. As such, the heating system 100 may be able to self-correct when in use to ensure that the substrate 126 reaches the desired temperature prior to spraying the spray coating material 128 onto the substrate 126.

The present disclosure thus provides an improved heating system for performing thermal spray coating and methods of use that increases thermal spray production time, as no separate step is needed to preheat the substrate. The heating system and methods described herein also reduces manufacturing cost since no separate heating facility is needed to preheat the substrate. Further, the heating system and methods described herein provides improved quality control, as the heating power and heating time period can be precisely adjusted to the desired level based on the particular materials of the substrate and spraying coating material.

The description of the different advantageous arrangements has been presented for purposes of illustration and description, and is not intended to be exhaustive or limited to the examples in the form disclosed. Many modifications and variations will be apparent to those of ordinary skill in the art. Further, different advantageous examples may provide different advantages as compared to other advantageous examples. The example or examples selected are chosen and described in order to best explain the principles of the examples, the practical application, and to enable others of ordinary skill in the art to understand the disclosure for various examples with various modifications as are suited to the particular use contemplated.

1. A heating system for performing thermal spray coating comprising:
a thermal spray element;
a heating unit;
at least one processor; and
data storage comprising program instructions executable by the at least one processor to cause the heating system to perform functions comprising:
receiving a first indication of a spray coating material positioned in the thermal spray element;
receiving a second indication of a material of a substrate onto which the spray coating material is to be sprayed;
heating, via the heating unit, the substrate for a time period until the substrate reaches a desired temperature, wherein the desired temperature is determined based on both the first indication of the spray coating material and the second indication of the material of the substrate; and
spraying, via the thermal spray element, the spray coating material onto the substrate.

2. The heating system of claim 1, wherein the heating system further includes a sensor, and wherein the functions further comprise:
detecting, via the sensor, a temperature of the substrate; and
adjusting a power of the heating unit based on the detected temperature of the substrate.

3. The heating system of claim 1, wherein the time period ranges from about 2 seconds to about 60 seconds.

4. The heating system of claim 1, wherein the desired temperature of the substrate ranges from about 120° F. to about 750° F.

5. The heating system of claim 1, wherein the heating unit comprises an infrared heating unit.

6. The heating system of claim 1, wherein the thermal spray element and the heating element are configured to be coupled to a robotic arm, and wherein a direction of the thermal spray element and a direction of the heating unit are independently controllable with respect to the robotic arm.

7. The heating system of claim 1, wherein the heating unit heats a localized heating zone of the substrate, and wherein the localized heating zone comprises a subset of a surface area of the substrate.

8. The heating system of claim 7, wherein the thermal spray element has a spray coating area that is less than an area of the localized heating zone.

9. The heating system of claim 8, wherein the localized heating zone ranges from about 5 cm² to about 50 cm², and wherein the spray coating area ranges from about 25 cm² to about 500 cm².

10. A method operable by the heating system of claim 1, the method comprising:
receiving the first indication of the spray coating material positioned in the thermal spray element;
receiving the second indication of the material of the substrate onto which the spray coating material is to be sprayed;
heating, via the heating unit, the substrate for the time period until the substrate reaches the desired temperature, wherein the desired temperature is determined based on both the first indication of the spray coating material and the second indication of the material of the substrate; and
spraying, via the thermal spray element, the spray coating material onto the substrate.

11. The method of claim 10, further comprising:
detecting, via a sensor of the heating system, a temperature of the substrate; and
adjusting a power of the heating unit based on the detected temperature of the substrate.

12. The method of claim 10, wherein heating the substrate for a time period comprises heating the substrate for about 4 seconds to about 60 seconds.

13. The method of claim 10, wherein heating the substrate to the desired temperature comprises heating the substrate to a temperature ranging from about 120° F. to about 750° F.

14. The method of claim 10, further comprising controlling a direction of the thermal spray element independently from a direction of the heating unit.

15. The method of claim 10, wherein heating the substrate comprises the heating unit heating a localized heating zone of the substrate, wherein the localized heating zone comprises a subset of a surface area of the substrate, and wherein spraying the spray coating material on the substrate comprises the thermal spray element spraying a spray coating area that is less than an area of the localized heating zone.

16. The method of claim 10, wherein spraying the spray coating material onto the substrate comprises spraying one of polyether ether ketone (PEEK), polyetherketoneketone (PEKK), or a thermoplastic polyester elastomer.

17. A non-transitory computer readable medium having stored thereon instructions, that when executed by one or more processors, cause the heating system of claim 1 to perform operations, the operations comprising:
receiving the first indication of the spray coating material positioned in the thermal spray element;
receiving the second indication of the material of the substrate onto which the spray coating material is to be sprayed;
heating, via the heating unit, the substrate for the time period until the substrate reaches the desired temperature, wherein the desired temperature is determined based on both the first indication of the spray coating material and the second indication of the material of the substrate; and
spraying, via the thermal spray element, the spray coating material onto the substrate.

18. The non-transitory computer readable medium of claim 17, wherein the operations further comprise:
detecting, via a sensor of the heating system, a temperature of the substrate; and
adjusting a power of the heating unit based on the detected temperature of the substrate.

19. The non-transitory computer readable medium of claim 17, wherein the operations further comprise:
controlling a direction of the thermal spray element independently from a direction of the heating unit.

20. The non-transitory computer readable medium of claim 17, wherein heating the substrate comprises the heating unit heating a localized heating zone of the substrate, wherein the localized heating zone comprises a subset of a surface area of the substrate, and wherein spraying the spray coating material on the substrate comprises the thermal spray element spraying a spray coating area that is less than an area of the localized heating zone.
